(19) United States
(12) Patent Application Publication
(10) Pub. No.: US 2020/0369114 A1
(43) Pub. Date: Nov. 26, 2020

(54) AIR CONDITIONING UNIT AND VEHICULAR AIR CONDITIONING DEVICE

(71) Applicant: MITSUBISHI HEAVY INDUSTRIES THERMAL SYSTEMS, LTD., Tolyo (JP)

(72) Inventor: Noriyuki CHIKAGAWA, Tokyo (JP)

(73) Assignee: MITSUBISHI HEAVY INDUSTRIES THERMAL SYSTEMS, LTD., Tokyo (JP)

(21) Appl. No.: 16/088,240

(22) PCT Filed: Jun. 26, 2017
(86) PCT No.: PCT/JP2017/023430

§ 371 Date: Sep. 25, 2018

(30) Foreign Application Priority Data
Jul. 5, 2016 (JP) 2016-133663

(51) Int. Cl. B60H 1/00; B60H 1/12

(52) U.S. Cl. CPC B60H 1/00671; B60H 1/12

(57) ABSTRACT

An object is to provide an air conditioning unit and a vehicular air conditioning device that can efficiently distribute conditioned air while preventing an increase in the dimensions of a damper. The air conditioning unit includes a main duct (D1), a subduct (D4) branching from the main duct (D1) and guiding air to a foot outlet port (24), and a second switching damper (30) disposed in the subduct (D4) facing the main duct (D1). The second switching damper (30) includes a rotating shaft (31) and a damper body (32) including a guiding shroud (33) extending in the circumferential direction around the rotating shaft (31). An end flange (34A) at one circumferential end of the damper body (32) protrudes into the main duct (D1) as a result of rotation of the second switching damper (30) around the rotating shaft (31). A radial length (R1) of an end flange (34A) is greater than a radial length (R2) of an end flange (34B) at the other circumferential end of the guiding shroud (33).

### TECHNICAL FIELD

The present invention relates to an air conditioning unit and a vehicular air conditioning device.

### BACKGROUND ART

A heating ventilation and air conditioning (HVAC) unit of an air conditioning device installed in a vehicle takes in outside air or vehicle cabin air (inside air) through an air flow channel in the unit case and controls the temperature of the air with an evaporator, a heater, and an air mixing damper. The temperature controlled, conditioned air selectively blows from one of multiple outlet ports provided in the unit case, such as a defroster outlet port, a face outlet port, and a foot outlet port, opening to the interior of the vehicle cabin, to control the cabin air at a predetermined temperature.

The unit case of such a vehicular air conditioning device accommodates various dampers, such as an inside/outside air selector damper, an air mixing damper, and multiple outlet mode dampers. The dampers are rotatably supported on the unit case and can be turned from the outside. The dampers turn individually or in cooperation with each other through manual operation or automatic control of levers rotatably supported on a side face of the unit case.

An example of such a damper is a plate-type damper including a damper plate and a shaft rotatably supporting the damper plate. The plate-type damper turns about the shaft to open/close a flow channel in communication with the outlet ports and selectively switches the outlet port from which the controlled air blows.

In the plate-type damper, the conditioned air blows onto the damper plate and generates a moment at the shaft. In the case where the rotational direction of the damper plate around the shaft during switching of the dampers is opposite to the direction of the moment generated in response to the damper plate receiving the conditioned air, a large operational torque is required for the switching of dampers.

In contrast, an air conditioning device disclosed in, for example, Patent Document 1 includes a flow guiding channel (flow direction changer) that has a sectoral shape centered on the rotary shaft and guides the flow of conditioned air, and a rotary damper that has opening ends at the two ends of the flow guiding channel in the circumferential direction around the rotary shaft.

Such a rotary damper is disposed at a bifurcation at which the channel branches into first and second sub-channels. The rotary damper is rotated around the rotary shaft to cause a first opening end of the flow guiding channel to project into the first sub-channel. When the first opening end of the rotary damper is retracted from the first sub-channel, the conditioned air flows along the first sub-channel without entering the second sub-channel from the first sub-channel. The first opening end of the rotary damper projecting into the first sub-channel causes the conditioned air flowing through the first sub-channel to flow from the first opening end of the flow guiding channel into the flow guiding channel and then through the second opening end of the flow guiding channel into the second sub-channel.

### CITATION LIST

### Patent Document

Patent Document 1: JP 2012-121383 A

### SUMMARY OF INVENTION

### Problem to be Solved by the Invention

In the case where the cross-sectional area of the second sub-channel is smaller than that of the first sub-channel in the air conditioning device including a rotary damper such as that described above, the conditioned air guided from the first sub-channel to the second sub-channel by projecting the first opening end of the rotary damper into the first sub-channel cannot readily flow into the second sub-channel because the cross-sectional area of the second sub-channel is small, and thus the pressure loss at the second sub-channel is large.

Thus, it is preferred that the first opening end of the flow guiding channel of the rotary damper project far into the first sub-channel. This, however, causes an increase in the dimensions of the rotary damper.

An object of the present invention, which has been conceived in light of the circumstances described above, is to provide an air conditioning unit and a vehicular air conditioning device that can efficiently distribute conditioned air while preventing an increase in the dimensions of a damper.

### Solution to Problem

To solve the above-described issues, an air conditioning unit and a vehicular air conditioning device according to the present invention adopts the following means.

An air conditioning unit according to the present invention includes a case including: an inlet port introducing air from outside and a plurality of outlet ports blowing the air to the outside; a temperature controller disposed inside the case and controlling a temperature of the air through heat exchange with the air introduced from the inlet port into to the case; a first duct disposed in the case and guiding the air passing through the temperature controller to at least one of the plurality of outlet ports; a second duct branching from the first duct and disposed in the case, the second duct guiding the air passing through the temperature controller to the outlet ports other than the at least one of the plurality of outlet ports; and a switching damper disposed in the second duct facing the first duct, the switching damper including a rotary shaft turning around the rotary axis in response to an external operational force and a damper body integrated with the rotary shaft and including a guiding shroud extending in a circumferential direction around the rotary shaft, the damper body having a first end portion at one end of the damper body in the circumferential direction protruding into the first duct by the switching damper rotating around the rotary shaft, and the first end having a radial length measured from the rotary shaft or a length in the duct width direction orthogonal to a flow direction of the first duct larger than a second end portion at the other end of the guiding shroud in the circumferential direction.

In the air conditioning unit according to the present invention, the radial length of the first end portion of the damper body is larger than that of the second end portion. Thus, the first end portion of the damper body can protrude farther into the first duct compared to when the radial length of the first end portion is the same as the radial length of the second end portion. In this way, a larger amount of air flowing through the first duct can be collected and fed to the second duct.

The second end portion of the damper body has a radial length smaller than that of the first end portion. Thus, the switching damper is prevented from projecting far out toward the second duct. Thus, the case can be prevented from having large dimensions due to an increase in the length of the second duct accommodating the damper body.

The length in the duct width direction of the first end portion of the damper body orthogonal to the flow direction of the first duct is larger than that of the second end portion. Thus, the first end portion of the damper body can protrude farther into the first duct compared to when the length in the duct width direction of the first end portion is the same as the length in the duct width direction of the second end portion. In this way, a larger amount of air flowing through the first duct can be collected and fed to the second duct.

The second end portion of the damper body has a length in the duct width direction smaller than that of the first end portion. Thus, the switching damper can be prevented from projecting far out toward the second duct. Thus, the case can be prevented from having large dimensions due to an increase in the width of the second duct accommodating the damper body.

It is preferred that the guiding shroud of the above-described air conditioning unit have a bulge disposed between the first end portion and the second end portion and protruding farthest radially outward from the rotary shaft.

The bulge of the guiding shroud of such an air conditioning unit can reduce the gap between the bulge of the guiding shroud and a case wall disposed radially outward from the bulge when the switching damper rotates around the rotary shaft such that the first end portion protrudes into the first duct. This can prevent the air flowing through the first duct from flowing around the switching damper and into the second duct through the gap.

In the above-described air conditioning unit, the radial length of the second end portion of the damper body is preferably ½ or greater the duct width orthogonal to the flow direction of the first duct.

In such an air conditioning unit, the radial length of the second end portion of the damper body significantly smaller than the duct width of the first duct increases the pressure loss at the second end portion and prevents a ready flow of air from the first duct to the second duct through the switching damper. In contrast, a radial length of the second end portion that is ½ or greater the duct width of the first duct prevents an increase in the pressure loss at the second end portion and facilitates the flow of air into the second duct.

In the above-described air conditioning unit, a flow channel area of the second end portion of the damper body is preferably ½ or greater the flow channel area of the first end portion.

In such an air conditioning unit, a flow channel area of the second end portion of the damper body that is significantly smaller than the flow channel area of the first end portion increases the pressure loss at the second end portion and prevents a ready flow of air from the first duct to the second duct through the switching damper. In contrast, a flow channel area of the second end portion that is ½ or greater the flow channel area of the first duct prevents an increase in the pressure loss at the second end portion and facilitates the flow of air into the second duct.

A vehicular air conditioning device according to the present invention includes one of the air conditioning units described above.

In the air conditioning unit of the vehicular air conditioning device according to the present invention, a larger amount of air flowing through the first duct can be collected and fed to the second duct. The case can be prevented from having large dimensions due to an increase in the length of the second duct accommodating the damper body.

### Advantageous Effect of Invention

An air conditioning unit and a vehicular air conditioning device according to the present invention can efficiently distribute conditioned air while preventing an increase in the dimensions of a damper.

### BRIEF DESCRIPTION OF DRAWINGS

FIG. 1 is a vertical cross-sectional view of an air conditioning unit according to the present invention.

FIG. 2 is a perspective view of a switching damper illustrated in FIG. 1 viewed from a rotary shaft.

FIG. 3 is a perspective view of the switching damper illustrated in FIG. 2 viewed from a guiding shroud.

FIG. 4 is an enlarged cross-sectional view of a portion of the switching damper of the air conditioning unit illustrated in FIG. 1.

FIG. 5 is a vertical cross-sectional view of the air conditioning unit with the switching damper projecting into a main duct.

FIG. 6 is a vertical cross-sectional view of the air conditioning unit with the switching damper slightly projecting into the main duct.

### DESCRIPTION OF EMBODIMENTS

Embodiments of the air conditioning unit and the vehicular air conditioning device according to the present invention will now be described with reference to the accompanying drawings.

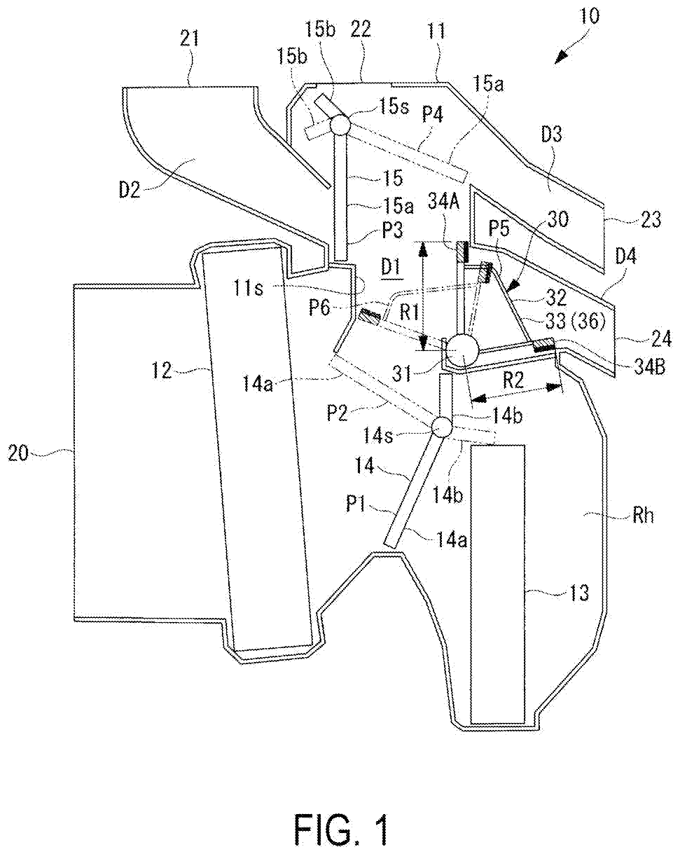

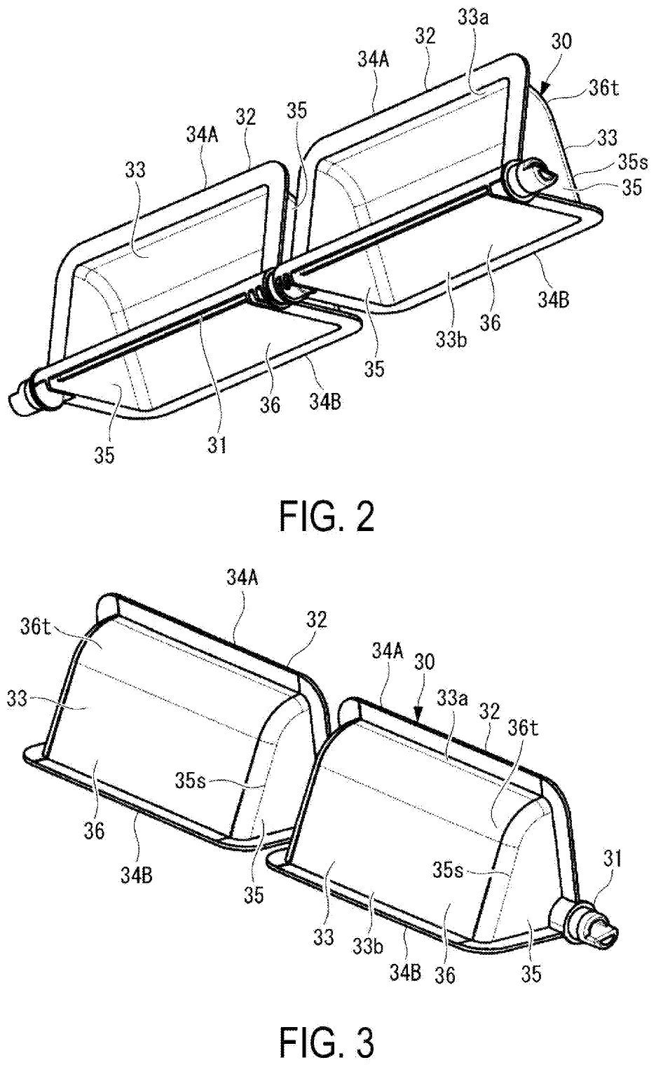

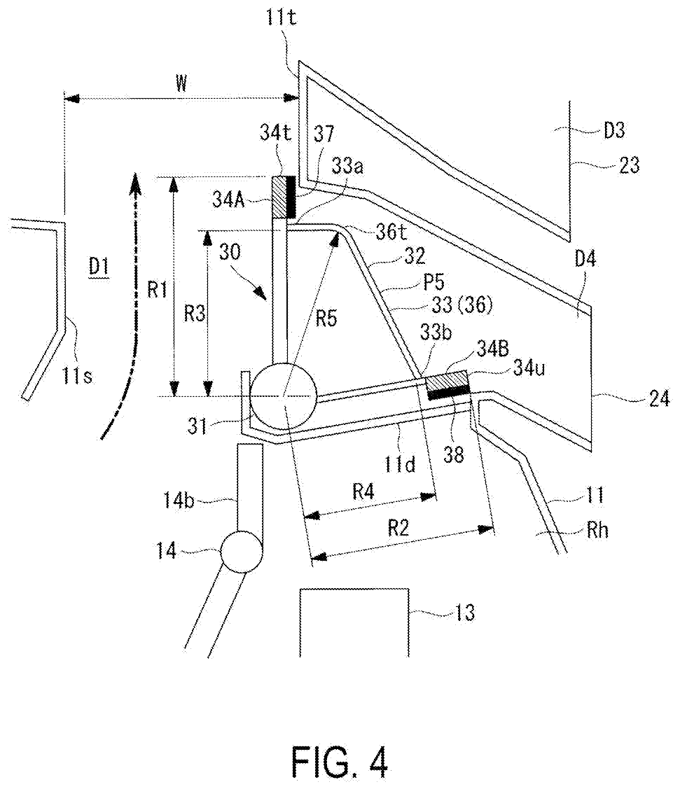

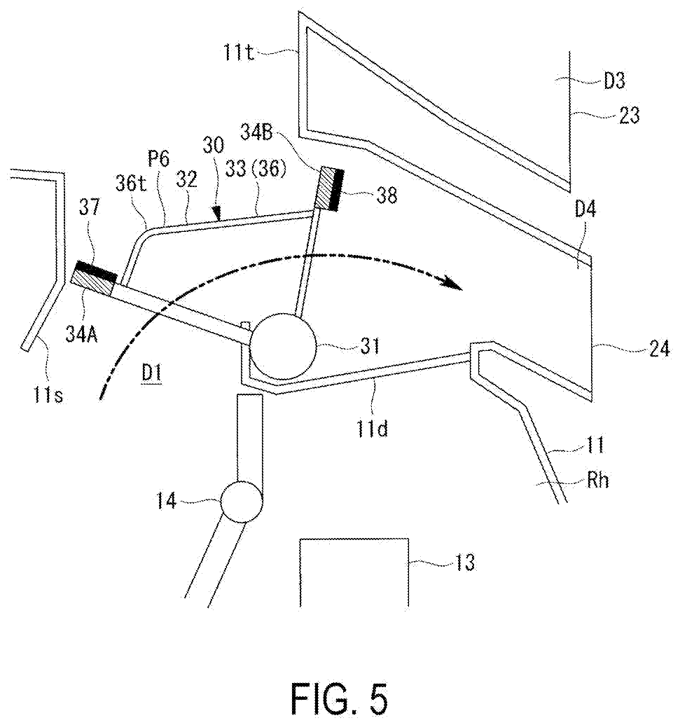

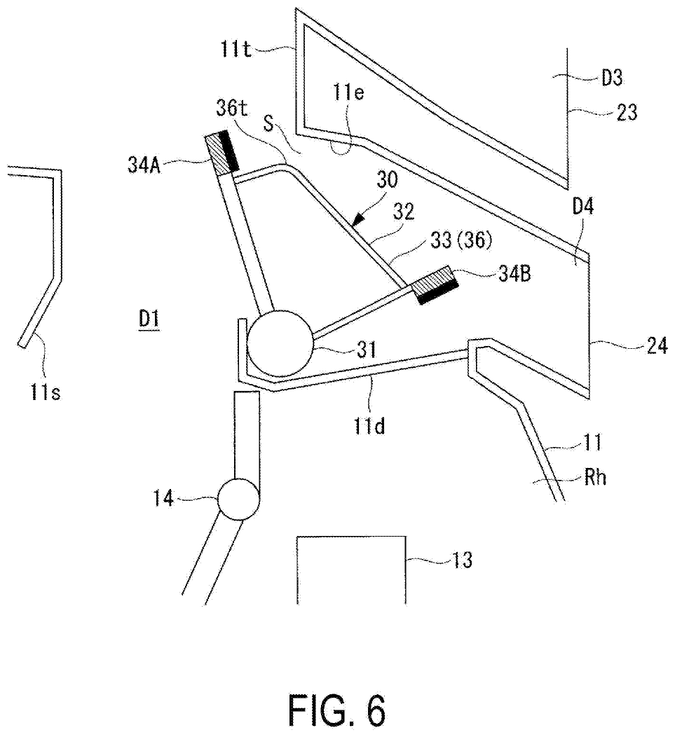

FIG. 1 is a vertical cross-sectional view of an air conditioning unit according to an embodiment. FIG. 2 is a perspective view of a switching damper illustrated in FIG. 1 viewed from a rotary shaft. FIG. 3 is a perspective view of the switching damper illustrated in FIG. 2 viewed from a guiding shroud. FIG. 4 is an enlarged cross-sectional view of a portion of the switching damper of the air conditioning unit illustrated in FIG. 1. FIG. 5 is a vertical cross-sectional view of the air conditioning unit with the switching damper projecting into a main duct. FIG. 6 is a vertical cross-sectional view of the air conditioning unit with the switching damper slightly projecting into the main duct.

With reference to FIG. 1, an air conditioning unit 10 of a vehicular air conditioning device is a heating ventilation and air conditioning (HVAC) module including a case 11, an evaporator (temperature controller) 12, a heater core (temperature controller) 13, and an air mixing (A/M) damper 14. In FIG. 1, the left corresponds to the front of the vehicle, and the right corresponds to the rear of the vehicle.

The case 11 is a hollow box having an inlet port 20, a defroster outlet port (outlet port) 21, a front face outlet port (outlet port) 22, a rear face outlet port (outlet port) 23, and a foot outlet port (outlet port) 24 that are openings establishing communication between the interior and the exterior of the case 11.

The inlet port 20 introduces the interior or exterior air of the vehicle cabin into the case 11 through a blower (not illustrated). The defroster outlet port 21 blows the interior air of the case 11 to the front windshield of the vehicle. The front face outlet port 22 blows the interior air of the case 11 onto areas of the body of the driver and/or passenger, such as the face, hands, and chest, in the front seat(s). The rear face outlet port 23 blows the interior air of the case 11 onto areas of the body of passenger(s), such as the face, hands, chest, in the rear seat(s). The foot outlet port 24 blows the interior air of the case 11 onto the feet of the driver and passengers. The defroster outlet port 21, the front face outlet port 22, the rear face outlet port 23, and the foot outlet port 24 can be connected to tubular ducts to guide the air to the targets to be blown, as required.

The evaporator 12 is disposed near the inlet port 20 in the case 11. A low-temperature, low-pressure refrigerant that is depressurized in a refrigeration cycle by an expansion valve or the like circulates through the interior of the evaporator 12 to cool the air introduced from the inlet port 20 into the case 11 through heat exchange with the refrigerant.

The heater core 13 is disposed in the case 11 in a heater core chamber Rh disposed downstream of the evaporator 12 in the flow direction of the air introduced through the inlet port 20. Water heated to a high temperature at the engine and/or a PTC heater circulates through the heater core 13 to heat the air passing through the heater core 13 through heat exchange with the high-temperature water.

The defroster outlet port 21 and the front face outlet port 22 are disposed adjacent to each other in the upper portion of the case 11.

A main duct (first duct) D1 extending upward from the downstream side of the evaporator 12 is provided in the case 11. The front face outlet port 22 opens at the downstream end of the main duct D1. A subduct D2 branching from the main duct D1 toward the front of the vehicle is provided in the upper portion of the main duct D1. The defroster outlet port 21 opens at the downstream end of the subduct D2.

In the case 11, a subduct D3 branching from the main duct D1 toward the rear of the vehicle is provided in the upper portion of the case 11. The rear face outlet port 23 opens at the downstream end of the subduct D3. A subduct (second duct) D4 branching from the main duct D1 toward the rear of the vehicle is provided in the intermediate portion of the case 11 in the vertical direction. The foot outlet port 24 is provided at the downstream end of the subject D4.

An air mixing damper 14 is disposed at the interface between the heater core chamber Rh accommodating the heater core 13 and the main duct D1. The air mixing damper 14 integrates a rotary shaft 14s rotationally driven in the direction around the shaft by an operational force generated by an external manual operation or automatic control, a main plate 14a extending from one side of the rotary shaft 14s, and a subplate 14b extending from another side of the rotary shaft 14s.

Rotation of the rotary shaft 14s causes the air mixing damper 14 to switch between a first state P1 indicated by the solid lines in FIG. 1 and a second state P2 indicated by the dash-double dot lines in FIG. 1.

The air mixing damper 14 in the first state P1 enters a cooling operation mode and closes the interface portion between the heater core chamber Rh and the main duct D1 with the main plate 14a and the subplate 14b. This causes the air passing through the evaporator 12 to flow into the main duct D1 without entering the heater core chamber Rh.

The air mixing damper 14 in the second state P2 enters a heating operation mode and closes the area between the front wall 11s of the main duct D1 and the heater core 13. This causes the air passing through the evaporator 12 to flow into the heater core chamber Rh and be heated at the heater core 13. The heated air then flows into the main duct D1.

The pivot angle of the air mixing damper 14 can be appropriately adjusted between the first state P1 and the second state P2, to adjust a mixing ratio of the air cooled at the evaporator 12 and the air heated at the heater core 13.

A first switching damper 15 that switches the air supply between the defroster outlet port 21, the front face outlet port 22, and the rear face outlet port 23 is provided in the upper portion of the case 11. The first switching damper 15 integrates a rotary shaft 15s rotationally driven in a direction around the shaft by an external operational force, a main plate 15a extending from one side of the rotary shaft 15s, and a subplate 15b extending from another side of the rotary shaft 15s.

Rotation of the rotary shaft 15s causes the first switching damper 15 to switch between a first state P3 indicated by the solid lines in FIG. 1 and a second state P4 indicated by the dash-double dot lines in FIG. 1.

The main plate 15a of the first switching damper 15 in the first state P3 closes the inlet of the subduct D2 in communication with the defroster outlet port 21. This causes the air passing through the main duct D1 to be fed to the front face outlet port 22 at the downstream end of the main duct D1 and the rear face outlet port 23 at the downstream end of the subduct D3.

The first switching damper 15 in the second state P4 blocks the main duct D1 at the downstream of the subduct D2. This causes the air passing through the main duct D1 to flow into the subduct D2 and to be fed to the defroster outlet port 21.

The pivot angle of the first switching damper 15 can be appropriately adjusted between the first state P3 and the second state P4, to adjust a distribution ratio of the air from the main duct D1 between the defroster outlet port 21, the front face outlet port 22, and the rear face outlet port 23.

A second switching damper (switching damper) 30 that switches the air supply to the foot outlet port 24 is disposed in an intermediate portion in the vertical direction of the case 11.

With reference to FIGS. 2, 3, and 4, the second switching damper 30 is rotatably supported on the case 11 (see FIG. 4) and integrates a rotary shaft 31 that turns in a direction around the shaft by an external operational force and damper bodies 32. With reference to FIGS. 2 and 3, the second switching damper 30 according to this embodiment includes, for example, two damper bodies 32 disposed along the axial direction of the rotary shaft 31.

The damper bodies 32 each include a guiding shroud 33 extending along the circumferential direction around the rotary shaft 31, an end flange (first end portion) 34A disposed at one end of the guiding shroud 33 in the circumferential direction, and another end flange (second end portion) 34B disposed at the other end of the guiding shroud 33 in the circumferential direction.

The guiding shroud 33 integrates side panels 35 and 35 disposed apart along the axial direction of the rotary shaft 31 and an outer panel 36 connecting outer circumferential edges 35s and 35s of the respective side panels 35 and 35.

Each side panel 35 is disposed in a plane orthogonal to the axial direction of the rotary shaft 31 and is connected to the rotary shaft 31. The side panel 35 has a sectoral shape in which the circumferential length gradually increases in the radially outward direction from the rotary shaft 31.

The outer panel 36 is continuous with the outer circumferential edges 35s and 35s of the respective side panels 35 and 35 in the circumferential direction around the rotary shaft 31. In this way, the cross section of the guiding shroud 33 taken along the direction orthogonal to the circumference has a U-shape.

With reference to FIGS. 2, 3, and 4, the end flange 34A is integrated with one end portion 33a of the guiding shroud 33 in the circumferential direction, and the end flange 34B is integrated with the other end portion 33b in the circumferential direction.

The end flanges 34A and 34B are disposed such that they extend outward from the guiding shroud 33 in directions orthogonal to the side panels 35 of the outer panel 36 and the outer panel 36. This causes the end flanges 34A and 34B to each have a U-shape.

With reference to FIG. 4, the end flanges 34A is provided with a sealing member 37 on the face adjacent to the guiding shroud 33. The end flange 34B is provided with a sealing member 38 on the face remote from the guiding shroud 33. The sealing members 37 and 38 are composed of a material such as rubber or a spongy flexible resin foam.

It is preferred that

R1>R2

holds for the end flange 34A, where R1 is the radial length from the rotary shaft 31 to the outer circumferential edge 34t in the radially outward direction and R2 is the radial length from the rotary shaft 31 of the end flange 34B to the outer circumferential edge 34u in the radially outward direction.

It is preferred that

R2≥½×W

holds for the radial length R2 of the other end flange 34B, where W is the duct width in the front-back direction of the main duct D1. A radial length R2 of the end flange 34B (downstream) of the second switching damper 30 significantly smaller than the duct width W of the main duct D1 increases the pressure loss at the end flange 34B. This prevents a ready flow of air to the subduct D4 connected to the foot outlet port 24 while guiding air from the main duct D1 to the subduct D4 with the second switching damper 30, as described below.

It is preferred that the outer panel 36 of the guiding shroud 33 disposed between the end flanges 34A and 34B have a radial length R3 from the rotary shaft 31 to the end flange 34A greater than a radial length R4 from the rotary shaft 3I to the end portion 33b adjacent to the end flange 34B.

The outer panel 36 has a bulge 36t along the circumferential direction near the end flange 34A. The bulge 36t protrudes farther radially outward than the other portions along the circumferential direction, such that its radial length R5 measured from the rotary shaft 31 is the largest.

Rotation of the rotary shaft 31 causes such a second switching damper 30 to switch between a first state P5 indicated by the solid lines in FIG. 1 and a second state P6 indicated by the dash-double dot lines in FIG. 1.

In the second switching damper 30 in the first state P5 as illustrated in FIG. 4, the end flange 34A is positioned along a sidewall 11t disposed in the main duct D1 toward the rear of the vehicle without protruding into the main duct D1, and the end flange 34B is positioned in contact with a partition 11d disposed in the lower area of the subduct D4 between the subduct D4 and the heater core chamber Rh. In this state, the sealing member 37 disposed on the end flange 34A comes into tight contact with the sidewall 11t of the main duct D1, and the sealing member 38 of the end flange 34B comes into tight contact with the partition 11d.

In this way, the second switching damper 30 seals the inlet of the subduct D4 in communication with the foot outlet port 24. Thus, the air flowing through the main duct D1 flows downstream without flowing into the subduct D4.

In the second switching damper 30 in the second state P6 as illustrated in FIG. 5, the end flange 34A protrudes into the main duct D1, and the end flange 34B is disposed away from the partition 11d and faces the subduct D4.

In this way, the air flowing through the main duct D1 changes its direction by flowing along the inner side of the end flange 34A into the guiding shroud 33 and through the end flange 34B into the subduct D4. Consequently, the air flowing through the main duct D1 can be fed to the foot outlet port 24.

The end flange 34A can protrude far into the main duct D1 because the radial length R1 is larger than the radial length R2 of the end flange 34B. In this way, a larger amount of the interior air of the main duct D1 can be collected and fed to the subduct D4.

The pivoting angle of the second switching damper 30 can be appropriately adjusted between the first state P5 and the second state P6, to adjust the distribution ratio of the air flowing through the main duct D1 between the foot outlet port 24, the defroster outlet port 21, the front face outlet port 22, and the rear face outlet port 23.

When the second switching damper 30 is slightly opened from the first state P5 as illustrated in FIG. 6 such that the end flange 34A is slightly apart from the sidewall 11t of the main duct D1, the bulge 36t in the outer panel 36 decreases a gap S between an upper wall 11e disposed above the second switching damper 30 in the case 11 and the outer panel 36 (bulge 36t). Thus, the second switching damper 30 slightly opened from the first state P5 can prevent the air from flowing from the subduct D4 through the gap S between the second switching damper 30 and the upper wall 11e into the main duct D1.

In the second switching damper 30 having the above-described configuration, the end flange 34A disposed at one circumferential end of the damper body 32 has a radial length R1 measured from the rotary shaft 31 larger than the radial length R2 of the end flange 34B at the other circumferential end of the guiding shroud 33. Thus, the end flange 34A of the damper body 32 protrudes farther into the main duct D1 compared to when the radial length R1 of the end flange 34A is the same as the radial length R2 of the end flange 34B. In this way, a larger amount of air flowing through the main duct D1 can be collected and fed to the subduct D4.

In particular, in the case where the second switching damper 30 is opened to an intermediate opening degree between the first state P5 and the second state P6 and air simultaneously blows from all of the front face outlet port 22, the rear face outlet port 23, and the foot outlet port 24, a larger amount of air flowing through the main duct D1 can be collected and efficiently fed to the subduct D4.

The end flange 34B of the damper body 32 has a radial length smaller than that of the end flange 34A. Thus, the second switching damper 30 is prevented from projecting far out toward the subduct D4. Thus, the case 11 can be prevented from having large dimensions due to an increase in the length of the subduct D4 accommodating the damper bodies 32.

In this way, the conditioned air can be efficiently distributed between the main duct D1 and the subduct D4 without an increase in the dimensions of the second switching damper 30 and the case 11.

The bulge 36t of the guiding shroud 33 of the air conditioning unit 10 can decrease the gap S between the bulge 36t of the guiding shroud 33 and the upper wall 11e of the case 11 disposed radially outward from the bulge 36t when the second switching damper 30 rotates around the rotary shaft 31 such that the end flange 34A shifts from a position along the sidewall 11t of the main duct D1 (first state P5) to a position protruding into the main duct D1. This prevents the air flowing through the subduct D4 from flowing around the second switching damper 30 and into the main duct D1 through the gap S.

In the air conditioning unit 10, the radial length R2 of the end flange 34B of the damper body 32 is ½ or greater the duct width W orthogonal to the flow direction of the main duct D1. This can prevent an increase in the pressure loss at the end flange 34B and facilitate the flow of air from the main duct D to the subduct D4 through the second switching damper 30.

In a vehicular air conditioning device (not illustrated) including the air conditioning unit 10 according to this embodiment, the air conditioning unit 10 can prevent an increase in the dimensions of the second switching damper 30 and the case 11 while efficiently distributing the conditioned air between the main duct D1 and the subduct D4.

In the above-described embodiment, the second switching damper 30 may be applied to any site besides the switching site between the main duct D1 and the subduct D4 connected to the foot outlet port 24.

The case 11 is provided with the defroster outlet port 21, the front face outlet port 22, the rear face outlet port 23, and the foot outlet port 24. Alternatively, any of the outlet ports may be omitted and/or any number of other outlet ports may be provided to feed air to other sections of the vehicle.

In the above-described embodiment, it is preferred that

R1>R2

holds, where R1 is the radial length of the end flange 34A from the rotary shaft 31 to the outer circumferential edge 34t in the radially outward direction and R2 is the radial length R2 of the end flange 34B from the rotary shaft 31 to the outer circumferential edge 34u in the radially outward direction. Alternatively, the length in the duct width direction of the end flange 34A orthogonal to the flow direction of the main duct D1 may be larger than the length in the duct width direction of the end flange 34B.

In this case also, the length in the duct width direction of the end flange 34A of the damper body 32 is larger than that of the end flange 34B. Thus, the end flange 34A of the damper body 32 can protrude farther into the main duct D1 compared to when the length in the duct width direction of the end flange 34A is the same as the length in the duct width direction of the end flange 34B. In this way, a larger amount of air flowing through the main duct D1 can be collected and fed to the subduct D4.

The end flange 34B of the damper body 32 has a length in the duct width direction smaller than that of the end flange 34A. Thus, the second switching damper 30 is prevented from protruding far out toward the subduct D4. Thus, the case 11 can be prevented from having large dimensions due to an increase in the width of the subduct D4 accommodating the damper bodies 32.

In the above-described embodiment, it is preferred that

R2≥½×W

holds for the radial length R2 of the end flange 34B, where W is the duct width in the front-back direction of the main duct D1. Alternatively, the end flanges may be defined by a flow channel area. In specific, the flow channel area of the end flange 34B of the damper body 32 may be ½ or greater the flow channel area of the end flange 34A.

In such a case also, an increase in the pressure loss at the end flange 34B can be prevented and the air can readily flow into the subduct D4.

### REFERENCE SIGNS LIST

10 Air conditioning unit
11 Case
12 Evaporator (temperature controller)
13 Heater core (temperature controller)
20 Inlet port
21 Defroster outlet port (outlet port)
22 Front face outlet port (outlet port)
23 Rear face outlet port (outlet port)
24 Foot outlet port (outlet port)
30 Second switching damper (switching damper)
31 Rotary shaft
32 Damper body
33 Guiding shroud
34A End flange (first end portion)
34B End flange (second end portion)
36t Bulge
D1 Main duct (first duct)
D4 Subduct (second duct)
R1 Radial length
R2 Radial length
S Gap
W Duct width

1.-5. (canceled)

6. An air conditioning unit comprising:
a case comprising an inlet port introducing air from outside and a plurality of outlet ports blowing the air to the outside;
a temperature controller disposed in the case and controlling a temperature of the air through heat exchange with the air introduced from the inlet port into to the case;
a first duct disposed in the case and guiding the air passing through the temperature controller to at least one of the plurality of outlet ports;
a second duct branching from the first duct and disposed in the case, the second duct guiding the air passing through the temperature controller to the outlet ports other than the at least one of the plurality of outlet ports; and
a switching damper disposed in the second duct facing the first duct,
the switching damper comprising
a rotary shaft turning around a rotary axis in response to an external operational force, and
a damper body integrated with the rotary shaft and comprising a guiding shroud extending in a circumferential direction around the rotary shaft,
the damper body having a first end portion at one end of the damper body in the circumferential direction protruding into the first duct by the switching damper rotating around the rotary shaft, and
the first end portion having a length in a duct width direction orthogonal to a flow direction of the first duct larger than radial length or the length in the duct width direction of a second end portion at the other end of the guiding shroud in the circumferential direction.

7. The air conditioning unit according to claim 6, wherein the guiding shroud comprises a bulge disposed between the first end portion and the second end portion and protruding farthest radially outward from the rotary shaft.

8. The air conditioning unit according to claim 6, wherein the radial length of the second end portion of the damper body is ½ or greater the duct width orthogonal to the flow direction of the first duct.

9. The air conditioning unit according to claim 6, wherein a flow channel area of the second end portion of the damper body is ½ or greater the flow channel area of the first end portion.

10. A vehicular air conditioning device comprising an air conditioning unit according to claim 6.
